(19) United States
(12) Patent Application Publication
(10) Pub. No.: US 2001/0046056 A1
(43) Pub. Date: Nov. 29, 2001

(54) Method and apparatus for the digital control of an element of a printing machine, and printing machine

(75) Inventors: Heiko Hunold, Wattenbek (DE); Christopher Liston, Rochester, NY (US); Patrick Metzler, Gettorf (DE); Gerhard Rudolf Sing, Kiel (DE); Lutz Michael Wagner, Kiel (DE)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 09/858,365

(22) Filed: May 16, 2001

Related U.S. Application Data
(60) Provisional application No. 60/204,971, filed on May 17, 2000.

(51) Int. Cl. B41B 1/00

(52) U.S. Cl. 358/1.1

(57) ABSTRACT

The invention relates to a method, apparatus and a printing machine (1) having a control device (8, 8′, 8″, 8′″) for the digital control of an element of the printing machine (1), an assignment (6, 6′) of two non-coincident digital variables (2 and 2′) being carried out.

The error of such an assignment (6, 6′) can be kept small in that, for successive assignments (6, 6′), an integer assignment (6, 6′) of small steps (3) of a first variable (2) to a large step (3′) of a second variable (2′) is carried out in such a way that for each assignment (6, 6′) the numerical ratio remains constant or is changed in such a way that the assignment error (4, 4′) never reaches the width (5) of the smaller steps (3) of the first variable (2) in any assignment (6, 6′).

The invention relates to a method for the digital control of an element of a printing machine with an assignment of two non-coincident digital variables, and to apparatus and a printing machine with a control device for implementing the method.

In printing machine control systems, variables often have to be assigned to one another. One example of this is the assignment of lines of image points to angular positions of the image cylinders. However there are many further examples of such assignments. Since, in order to be able to calculate such variables better, they are often digitized, there is the problem that they can often be assigned to one another only in an integer manner, that this integer assignment does not work and is, therefore, affected by an error. If, however, the variables to be assigned to one another are a number of successive assignments, then such an error adds up. Since, in order to limit the computing effort, the step size of the digitization of a variable should not be selected to be too small, the problem, therefore, occurs that the integer assignment in the case of a number of successive assignments ultimately leads to an error whose magnitude is no longer tolerable.

The invention is, therefore, based on the object of designing the digital control of an element of a printing machine in such a way that the error when assigning two non-coincident digital variables is kept low even when a number of successive assignments are made.

With regard to the method, the object is achieved in that, for successive assignments, an integer assignment of small steps of a first variable to a large step of a second variable is made in such a way that, for each assignment, the numerical ratio remains constant or is changed in such a way that the assignment error never reaches the width of the smaller steps of the first variable in any assignment.

With regard to the apparatus and the printing machine, the object is achieved by the control device being designed in such a way that, for a successive assignment of two non-coincident digital variables, it performs an integer assignment of the small steps of the first variable to a large step of the second variable in such a way that the numerical ratio remains constant or is changed in such a way that the assignment error never reaches the width of the smaller steps of the first variable in any assignment.

The basic idea of the invention is that, during the assignment of smaller steps to larger steps, and in the case of a succession of such assignments, an increasing error magnitude can be compensated for by the fact that, beginning at a specific error magnitude, one step more or one step less is assigned, so that the magnitude of the error does not exceed a specific magnitude.

For the practical implementation, there are various options in this case. For example, the residuals which remain from the assignment can be collected until an additional step of the variable has come together with the small steps, which additional step is then assigned, in addition to the relevant step of the variable, to the large steps as compensation. Conversely, it is, of course, also possible for error magnitudes to be collected and then for one step to be left out. For the first-mentioned case, a development of the apparatus provides for the control device to have a memory in which, during each assignment of the smaller steps of the first variable to the larger steps of the second variable, the remaining, non-integer residual is set, and in that, during the calculation of the assignment of the steps of the smaller variable to the next step of the larger variable, the controller adds this residual. Of course, in the same way, error magnitudes could also be set into the memory for the calculation of the next assignment. These assignments ensure that the assignment errors never reach the width of the smaller steps, since then the additional step is always added or one is left out.

A development of the method provides for the numerical ratio of the assignment to remain constant or to change in such a way that the assignment error never exceeds half the width of the digital steps of the smaller variable in any assignment. The apparatus for implementing this development of the method provides for the control device to be designed in such a way that for an assignment of the steps, it forms the sum of the magnitudes to be assigned and the assignment error for the preceding assignment of steps and rounds up if the magnitude exceeds half a smaller step and rounds down if the magnitude falls below half a smaller step. By means of this development, the assignment error can, thus, be minimized to a maximum of half the magnitude of the smaller steps.

An important field of use of the invention is the control of register in a multicolor printing machine, the assignment according to the invention being used to control the production of lines of image points on the image cylinders by the image production equipment assigned to the latter. For example, an assignment of lines of image points produced on the image cylinders to fixed angular sequences of the image cylinders can be provided.

In this way, the error always remains less than one line of image points or less than an angular sequence, depending on which is selected as the variable with the smaller steps.

In this case, it is possible for the register control system, in order to assign the color separations to the color printing units, to subdivide the color separations into areas, which are produced in such a way that they come together with the correct assignment when the color separations are transferred to a printing substrate. This can be achieved by each area consisting of a fixed number of lines of image points, and the maintenance of register being provided by controlling the assignment of the lines to the angular sequences.

In this case, provision can be made, in order to achieve coincidence of register of the color separations produced by the color printing units, for the said color separations to be subdivided into areas which are assigned to one another, the areas consisting of a fixed number of lines of image points. Two assignments are, therefore, carried out, the mutual assignment of the areas of the color separations set up by the individual color printing units and, within one area, an assignment of the lines of image points to the angular sequences, the latter being performed by means of the magnitudes calculated and to be assigned for each area which, on the one hand, constitute a measure of the required size of an area and, on the other hand, are used according to the invention to distribute an error uniformly over the respective area since, as a result of the assignment of the lines of image points to the fixed angular sequences, a change in the spacing of the lines of image points, which distributes the magnitude of an error, is carried out in an optimum way.

However, for the principle of the invention, it is unimportant whether a number of lines of image points are assigned to an angular sequence or a number of angular sequences are assigned to a line of image points. Although the register control assigns a large number of lines of image points to one another block-by-block, so to speak, by means of the areas of the color separations, a distribution of the errors takes place within these blocks, as a result of the assignment according to the invention of the lines to the angular sequences, in such a way that these errors are no longer visible in the print. As a result, the computing effort can be reduced considerably by comparison with the assignment of individual lines, and, nevertheless, the production of visible errors is avoided. The aim of achieving high print quality with low computing effort is, therefore, achieved. With regard to the apparatus, a control system is set up in such a way that it controls the image production equipment in the aforementioned way.

In order to control the production of images with the aid of the measure of the invention, the assignment of the lines of image points to fixed angular sequences can be based on measuring the positions of elements that carry images and substrates. Furthermore, the calculation of the assignment of the areas of the color separations to one another, and the assignment of the lines of image points to the angular sequences, can be based on the acquisition and evaluation of the data from register marks printed by the color printing units. Expediently, the two are combined with each other, in particular when further influences are added, such as the image transfer behavior of image transfer cylinders with elastic surfaces, which has to be included in the calculation of the image production.

In order to implement these method steps, with regard to the apparatus, provision is made for it to have sensors for measuring the position of elements that carry images and substrates, and for the control device to be set up in such a way that it performs the assignment on the basis of the position measurement. Furthermore, provision can be made for the control device to be set up in such a way that it initiates the printing of register marks, a sensor being arranged to detect the register marks and the control device being set up in such a way that it evaluates the data from the register marks in such a way that the assignment of the areas of the color separations to one another is carried out to achieve coincidence of register, and the assignment of the lines of image points to angular sequences is carried out to reduce the error.

The invention will be explained below using the drawing, in which:

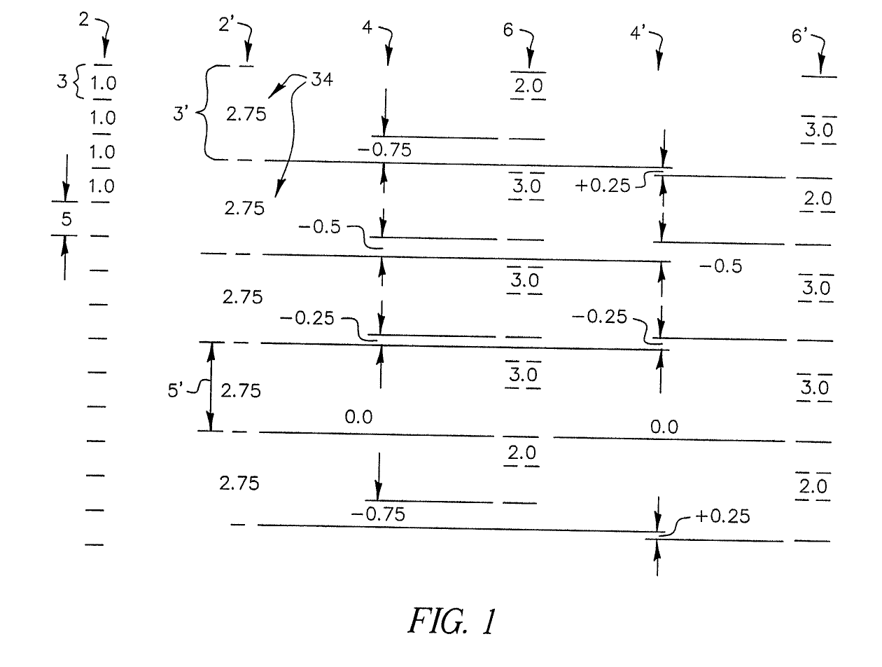

FIG. 1 shows an exemplary basic sketch to explain the method according to the invention;

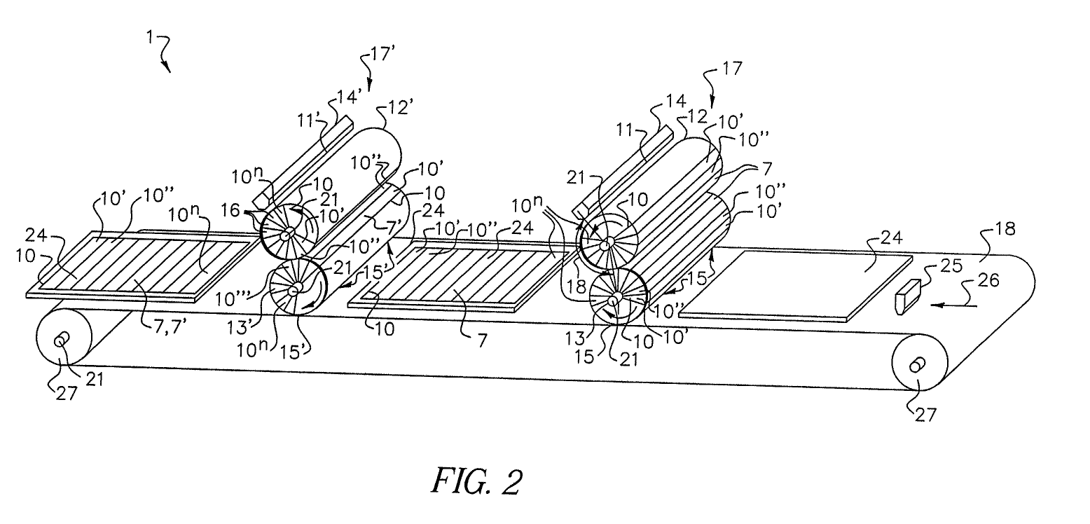

FIG. 2 shows the operating principle of a multicolor printing machine, whose register can be set with the aid of the method according to the invention;

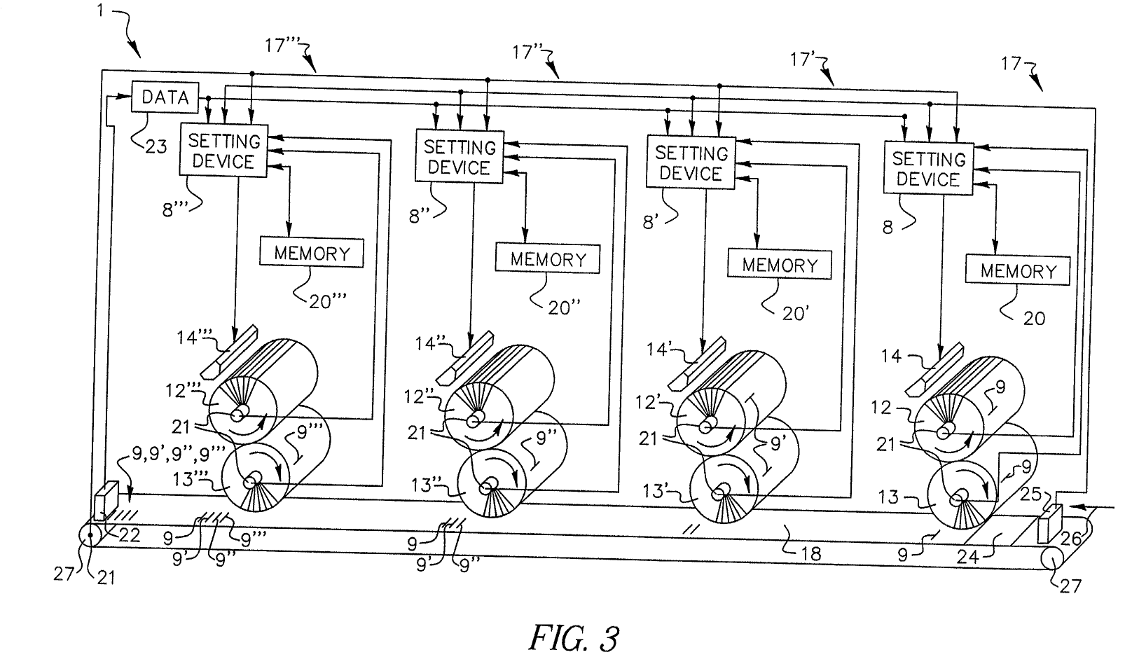

FIG. 3 shows an exemplary embodiment of a multicolor printing machine with a control device;

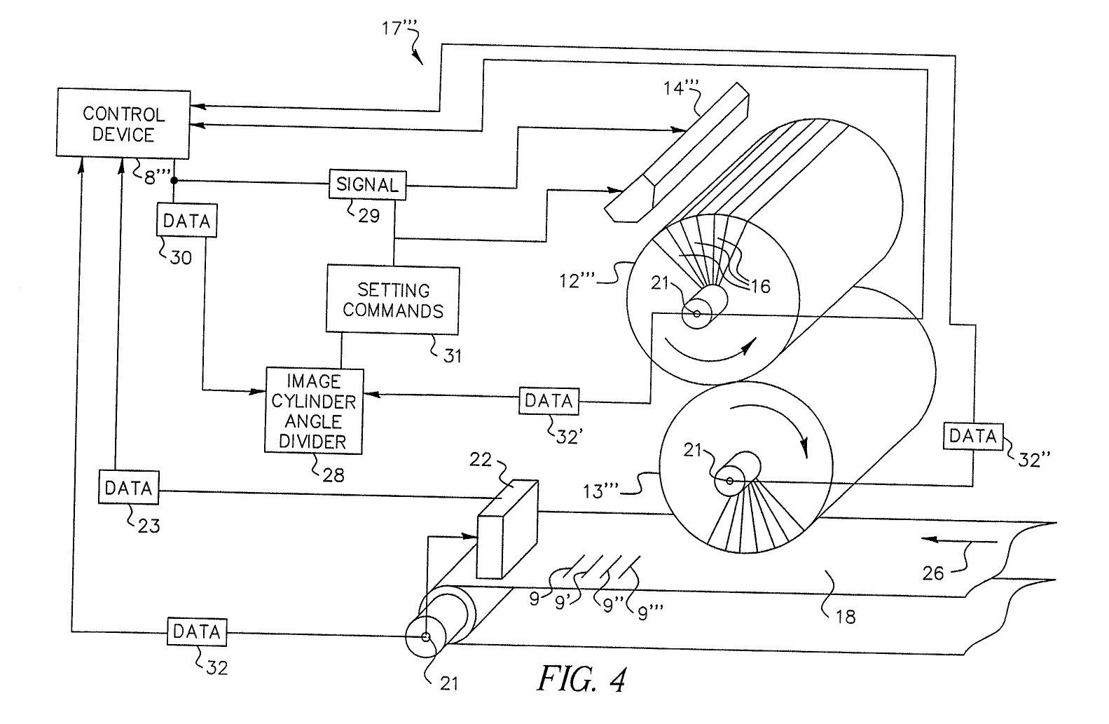

FIG. 4 shows a detail from FIG. 3; and

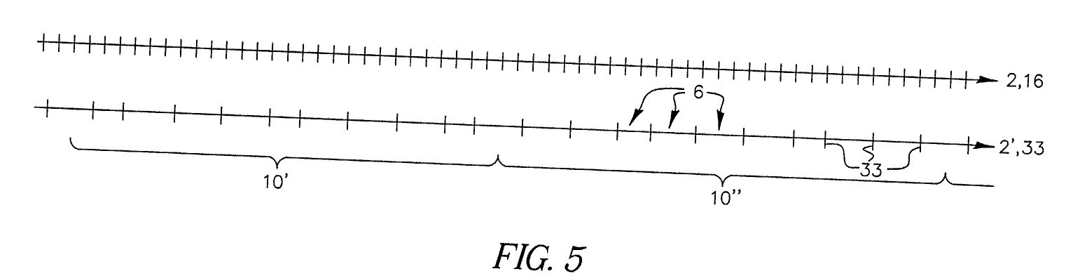

FIG. 5 shows an exemplary embodiment of an assignment of lines of image points, which form areas, to angular sequences by means of a control device according to the invention.

FIG. 1 shows a basic sketch to explain the method according to the invention. In this case, the intention is for a first digital variable 2 to be assigned to a second digital variable 2′. The steps 3 of the first digital variable 2 have a width 5, whose size is indicated by way of example as 1.0. The steps 31 of the second digital variable 2′, on the other hand, have a greater width 5′, whose size is indicated as 2.75. This magnitude 34 to be assigned is assumed here by way of example and is indicated as the number of steps 3 of the first variable 2 to which one step 3′ of the second variable 2′ can be assigned in non-digital form. The magnitude 34 to be assigned can, of course, be completely arbitrary, the values indicated are used merely for clarification by means of the drawn illustration.

Shown as an example for an assignment according to the invention are the assignments 6, 6′. In the case of the assignment 6, firstly two steps 3 with a step width 5 of 2.0 of the first variable 2 are assigned to the second variable 2′. During this assignment, an assignment error 4 of −0.75 was produced. Then, three steps 3 of the variable were assigned to a step 3′ of the variable 2′, an assignment error 4 of −0.5 resulting. This was followed by an assignment of again 2×three steps 3 with an assignment error 4 of, firstly, −0.25, and then with 0. This assignment then begins again from the start. In the case of this assignment 6, therefore, the resulting residual 4 is always summed until a further whole step 3 can be accommodated. In this way, the assignment error 4 will always remain below the magnitude of a step 3, that is to say will never reach the value 1.0.

The assignment 6′ shows another method, in which rounding up and rounding down is carried out in each case, and, therefore, the error 0.5 of a step 3 is never exceeded. In the illustration, first of all the magnitude 34 of 2.75 to be assigned is rounded up to 3, which results in an error magnitude 4′ of +0.25. Then, two steps 3 are assigned to a step 3′, and an error magnitude 4′ of −0.5 is produced. After that, again three steps 3 are assigned to a step 3′, an error magnitude 4′ of −0.25 being produced. Finally, an assignment of three steps 3 is carried out, that is to say of 3.0, the error magnitude being 0.

The assignments 4, 4′ illustrated are, of course, pure numerical examples. In the case of the assignments to be performed, series are generally produced in which the assignment error becomes 0 once at most as an exception. In addition, the differences between the steps 3 and 3′ to be assigned can also be significantly greater.

FIG. 2 shows the principle of a multicolor printing machine 1, whose register can be set in accordance with the invention. A multicolor printing machine 1 of this type generally comprises four and more color printing units 17, 17′, 17″, 17′″. For the purpose of simplification, only two color printing units 17 and 17′ have been illustrated. These color printing units 17, 17′ have image cylinders 12, 12′, . . . and image production equipment 14, 14′, . . . for the production of color separations 7, 7′, . . . , for example, electrostatic latent images. These color separations 7, 7′, . . . are transferred from the image cylinders 12, 12′, . . . to image transfer cylinders 13, 13′, . . . , in order then to be applied to printing substrates 24 by these image transfer cylinders 13, 13′, . . . . Each color printing unit 17, 17′, applies one color separation 7, 7′, . ., which together result in the color print.

The prints whose register is to be set have image starts 10 and are subdivided into areas 10′, 10″, . . . , 10 ⁿ, this subdivision being performed for each color separation 7, 7′, in order to control the production of the areas 10, 10′, 10″, . . . , 10ⁿin such a way that accurately registered overprinting both of the image starts 10 and of the areas 10′, 10″, . . . , 10ⁿ can be achieved.

In order to achieve this register setting, the image production equipment 14, 14′, . . . is controlled in such a way that the image production points 11, 11′, . . . produce the image starts 10 and the areas 10′, 10″, . . . , 10ⁿin such positions on the image cylinders 12, 12′, . . . that the color separations 7, 7′,. . relating to all the defined areas 10, 10′, 10″, . . . , 10ⁿare printed on one another. In order to achieve this, sensors 21 are provided for measuring the positions of all the elements 12, 12′, . . . , 13, 13′, . . . , 18 that carry images and substrates. Also provided is a sensor 25 for detecting printing substrates 24, which gives an appropriate message to the control device 8, 8′, 8″, 8′″.

The printing substrates 24 are transported in the direction of the arrow 26 by a carrier 18 for printing substrates 24, and are provided with a color separation 7, 7′, . . . at each color printing unit 17, 17′at an image transfer point 15′. Opposite the image transfer points 5, 5′, . . . , that is to say, on the other side of the carrier 18, there are also impression cylinders, which support the transfer of the color separations 7, 7′, . . . to the printing substrates 24 mechanically and electrostatically. These impression cylinders are not shown, for reasons of simplicity.

The configuration shown of the invention proposes to assign lines of image points 33 of the color separations 7, 7′, . . . to defined angular positions 16 of the image cylinders 12, 12′, . . . in such a way that each line of image points 33 is assigned to a defined angular sequence 16 of the respective image cylinder 12, 12′, . . . . In this case, however, the lines of image points 33 are not drawn, since these are too small for this purpose, but areas 10′, 10″, . . . , 10ⁿ which consist of a number of lines of image points 33. In addition, the defined angular sequences 16 and the defined areas 10, 10′, 10″, . . . , 10ⁿ are drawn significantly larger, since they are so small that they cannot be shown by drawing in this manner; a subdivision with the maximum fineness is necessary to achieve quality prints. The principle of the assignment 6, 6′of lines of image points 33 to angular sequences 16 corresponds to the principle explained in relation to FIG. 1, and a concrete example of this is further given by FIG. 5 with description. A sensor 22 for the detection of register marks 9, 9′, 9″, 9′″ can also be used for the control, being shown and explained in FIG. 3.

FIG. 3 shows an exemplary embodiment of a multicolor printing machine 1 having a control device 8, 8′, 8″, 8′″, with which the method according to the invention can be applied when setting the register. In this case, the construction and functioning correspond to those described above. In the case of this multicolor printing machine 1, each color printing unit 17, 17′, 17″, 17′″is assigned a unit 8, 8′, 8″, 8′″ of the control device, which controls the image production equipment 14, 14′, . . . for producing the color separations 7, 7′, . . . in such a way that the image production points 11, 11′, . . . are placed on the image cylinders 12, 12′, . . . in such a way that the color separations 7, 7′, . . . are printed in exact register one above another when transferred to a printing substrate 24.

For this purpose, a dimension (magnitude 34 to be assigned) of the assignment 6, 6′of lines of image points 33 to angular sequences 16 of the image cylinders 14, 14′, 14″, 14′″ has to be found for each area 10′, 10″, . . . , 10ⁿ of a color separation 7, 7′. . . . For this purpose, sensors 21 for measuring position can be used, or provision can be made for register marks 9, 9′, 9″, 9′″ to be printed. In this case, each printing unit 17, 17′, 17″, 17′″ prints at least one register mark 9, 9′, 9″, 9′″. Thus, for example, one register mark 9 is produced by the image production equipment 14 for producing the color separation 7 on the image cylinder 12, and is then transferred to the carrier 18 by means of the image transfer cylinder 13. In a corresponding way, register marks 9′, 9″, 9′″ are set up by the color printing units 14′, 14″, 14′″. These register marks 9, 9′, 9″, 9′″ are detected by means of a sensor 22, and the data 23 from the register marks 9, 9′, 9″, 9′″ is given to the control device 8, 8′, 8″, 8′″. By means of this data 23, the image starts 10 and the areas 10′, 10″, . . . , 10ⁿ of the color separations 7, 7′, . . . can be assigned to one another; in relation to the areas 10′, 10″, . . . , their size is determined, which is needed for the accurately registered meeting of the color separations 7, 7′, . . . . This size of an area 10′, 10″, . . . , or 10ⁿ is set by the invention by means of the assignment of lines of image points 33 to angular sequences 16 in such a way that the most uniform possible distribution of the magnitude of an error over the area 10, 10′, . . . , 10ⁿ is achieved (see FIG. 5).

The control devices 8, 8′, 8″, 8′″, preferably the units assigned to each color printing unit 17, 17′, 17″, 17″′, calculate an assignment 6, 6′, as was described in relation to FIG. 1. For this purpose, in each case memories 20, 20′, 20″, 20′″ can be provided, in which, following each assignment 6, 6′ of steps 3, 3′, the assignment errors or residuals 4, 4′, which do not fit, are set, in order then to take these into account in the manner described above when calculating the next assignment 6, 6′ of steps 3, 3′ of the variables 2, 2′.

Here, the variables 2, 2′ can also be angular sequences 16 of the image cylinders 12′, 12″, 12′″, lines of image points 33 and/or areas 10′, 10″, . . . , on of the color separations 7, 7′, . . . . Of course, further assignments 6, 6′ are also possible, such as angular sequences 16 of the image cylinders 12, 12′, 12″, 12″′, angular sequences of the image transfer cylinders 13, 13′, 13″, 13′″ and angular sequences of a roller 27 of the carrier 18 for printing substrates 24, for example. If such angular sequences are measured by means of sensors 21, for example angular position transmitters, then a register setting is possible in this way as well. Preferably, however, both the aforementioned angular sequences and register marks 9, 9′, 9″, 9′″ are evaluated and used for a register setting.

FIG. 4 further shows a detail from FIG. 3, it being shown that, in addition to the data 23 from the register marks from the sensors 21, data 32 about the positions of the carrier 18 of the printing substrates 24, data 32′ about positions of the image cylinder 12″, and data 32″ about positions of the image transfer cylinder 13′″, can be given to the control device 8′″, in order to assign the positions of these elements 12, 12′, 12″, 12′″; 13, 13′, 13″, 13′″; and 18 that carry images and substrates to one another in the aforementioned way.

Furthermore, a more detailed configuration between a unit 8′″ of the control device 8, 8′, 8″, 8′″ and an item of image production equipment 14′″ is shown. In this case, an image cylinder angle divider 28 is provided, which is given the data 32′from the image cylinder 12′″ by an angle position transmitter 21, in order to assign the lines of image points 33 to the angular sequences 16. In this case, the control device 8′″ gives a signal 29 to start the image start 10 and, at the same time, gives the data 30 from the areas 10′, 10″, . . . , 10ⁿ of the corresponding color separation 7, 7′, . . . to the image cylinder angle divider 28, which assigns this data 30 to the angular sequences 16 and, as a result, can give the setting commands 31 to the image production equipment 14′″, in order that the latter performs the image production at the correct image production points 11, 11′, . . . .

FIG. 5 shows an exemplary embodiment of an assignment 6 of lines of image points 33 to angular sequences 16. In this case, for example, each defined area 10′, 10″, . . . , 10ⁿ, can contain a specific number of lines of image points 33. The assignment of ten lines of image points 33 to the areas 10′, . . . is merely an example, in fact significantly more lines of image points 33 are assigned. In addition, the assignment 6, which has been illustrated here in accordance with the example of FIG. 1, can be carried out in any desired way, and can also be performed in the same way as the assignment 6′ or in yet another way.

In order that the areas 10′, 10″, . . . , 10ⁿ of the color separations 7, 7′, . . . can be coordinated exactly with one another, the control device 8, 8′, 8″, 8′″ is expediently configured in such a way that it calculates the magnitudes 34 to be assigned for each area 10′, 10″, . . . , 10ⁿ and, in accordance with these calculations, the assignments 6 of the lines of image points 33 for each area 10′, 10″, . . . , 10ⁿ are performed in accordance with the respectively calculated magnitude 34 to be assigned.

In this way, not only are the position and size of the areas 10′, 10″, . . . , 10ⁿ determined exactly, but also the lines of image points 33 of which the areas 10′, 10″, . . . , in consist are in each case placed with the smallest 5 possible assignment error 4, 4′. In this way, therefore, even within the areas 10′, 10″, . . . , 10ⁿ, the changes in the spacing of the lines of image points 33, which distribute the magnitude of the error and have already been mentioned above, are carried out.

Of course, FIG. 5 constitutes only an exemplary embodiment of an assignment 6, 6′of the lines of image points 33 to angular sequences 16. Other assignments are also conceivable, for example the assignment of a number of lines of image points 33 to an angular sequence 16 each. In addition, in this way, image productions and angular positions or other settings of other elements of printing machines can be performed; the invention is, of course, not limited to controlling register, even if this is a significant field of application of the invention.

### Parts List

1 Printing machine, for example, multicolor printing machine

2, 2′ First and second digital variable

3, 3′ Steps of the first (smaller) and second (larger) variable

4, 4′ Assignment error or residual which does not fit

5, 5′ Width of the digital steps

5 Smaller steps (first variable)

5′ Larger steps (second variable)

6, 6′ Assignments

7, 7′ Color separations

8, 8′, 8″, 8′″ Control device, for example, register control system with units which are assigned to the color printing units

9, 9′, 9″, 9′″, Register marks (various color printing units)

10, 10′, 10″, . . . , 10ⁿ Defined areas of the color separations

10 Image starts (beginning of image setting)

10′, 10″, . . . , 10ⁿ Areas of the color separations into which the image area is subdivided

11, 11′, . . . Image production points

12, 12′, 12″, 12′″ Image cylinders

13, 13′, 13″, 13′″ Image transfer cylinders

14, 14′, 14″, 14′″ Image production equipment for producing color separations, for example, electrostatic latent images

15, 15′, 15″, 15′″ Image transfer points

16 Angular sequences

17, 17′, 17″, 17′″ Color printing units

18 Carrier for printing substrates

19, 19′, 19″, 19′″ Register marks

20, 20′, 20″, 20′″ Memories

21 Sensors for measuring position

22 Sensor for detecting the register marks

23 Data from the register marks

24 Printing substrates

25 Sensor for detecting printing substrates

26 Arrow: transport direction of the printing substrates

27 Rollers of the carrier for printing substrates

28 Image cylinder angle divider

29 Signal for the start of the image start

30 Data from the areas of the color separations

31 Start commands: data 30 assigned to the angular sequences of the image cylinder

32 32′, 32″ Data from the angular position transmitter

32 Data from the carrier for printing substrates

32′ Data from the image cylinder

32 ″ Data from the image transfer cylinder

33 Lines of image points

34 Magnitudes to be assigned (specified here as the number of steps of the first variable which can be assigned to a step of the second variable in non-digital form)

What is claimed is:

1. A method for the digital control of an element of a printing machine (1) with an assignment (6, 6′) of two non-coincident digital variables (2 and 2′), wherein, for successive assignments (6, 6′) an integer assignment (6, 6′) of small steps (3) of a first variable (2) to a large step (3′) of a second variable (2′) is carried out in such a way that for each assignment (6, 6′) the numerical ratio remains constant or is changed in such a way that the assignment error (4, 4′) never reaches the width (5) of the smaller steps (3) of the first variable (2) in any assignment (6, 6′).

2. The method as claimed in claim 1, wherein the numerical ratio of the assignment (6, 6′) remains constant or changes in such a way that the assignment error (4, 4′) never exceeds half the width (5) of the digital steps (3) of the smaller variable (2) in any assignment (6, 6′).

3. The method as claimed in claim 2, wherein it is used to control register in a multicolor printing machine (1) by controlling the production of lines of image points (33).

4. The method as claimed in claim 3, wherein it is used to assign (6, 6′) lines of image points (33) produced on the image cylinders (12, 12′, 12″, 12′″) to fixed angular sequences (16) of the image cylinders (12, 12′, 12″, 12′″).

5. The method as claimed in claim 4, wherein, in order to achieve coincidence of register between the color separations (7, 7′, . . . ) produced by the color printing units (17, 17′, 17″, 17′″), said color separations are subdivided into areas (10′, 10″, . . . , 10ₙ) which are assigned to one another, the areas (10′, 10″, . . . , 10ⁿ) consisting of a fixed number of lines of image points (33).

6. The method as claimed in claim 5, wherein the assignment (6, 6′) is based., on measuring the positions of elements (12, 12′, 12″, 12′″, 13, 13′, 13″, 18) that carry images and substrates.

7. The method as claimed in claim 6, wherein the assignment of the areas (10′, 10′, . . . , 10ₙ) of the color separations (7, 7′, . . . ) to one another, and the assignment (6, 6′) of the lines of image points (33) to the angular sequences (16) is based on the acquisition and evaluation of the data (23) from register marks (19, 19′, 19″, 19′″) printed by the color printing units (6, 6′, 6″, 6′″).

8. Apparatus for implementing a method as claimed in claim 7 with a control device (8, 8′, 8″, 8′″), wherein the control device (8, 8′, 8″, 8′″) is designed in such a way that, for a successive assignment (6, 6′) of two non-coincident digital variables (2 and 2′), it performs an integer assignment (6, 6′) of the small steps (3) of the first variable (2) to a large step (3′) of the second variable (2′) in such a way that the numerical ratio remains constant or is changed in such a way that the assignment error (4, 4′) never reaches the width (5) of the smaller steps (3) of the first variable (2) in any assignment (6, 6′).

9. The apparatus as claimed in claim 8, wherein the control device (98, 8′, 8″, 8′″) has a memory (20, 20′, 20″, 20′″) in which, during each assignment (6, 6′) of the smaller steps (3) of the first variable (2) to the larger steps (3′) of the second variable (2′), the remaining, non-integer residual (4, 4′) is set and, during the calculation of the assignment of the steps (3) of the smaller variable (2) to the next step (3′) of the larger variable (2′), the control system (8, 8′, . . . 8″, 8′″) adds this residual (4, 4′).

10. The apparatus as claimed in claim 9, wherein the control device (8, 8′, 8″, 8′″) is designed in such a way that, for an assignment (6′) of the steps (3, 3′), it forms the sum of the magnitude (34) to be assigned and the assignment error (4′) of the previous assignment (6′) of steps (3 and 3′), and rounds up if the magnitude exceeds half a smaller step (3) and rounds down if the magnitude falls below half a smaller step (3).

11. The apparatus as claimed in claim 10, wherein the control device (8, 8′, 8″, 8′″) is used to control the register of a multicolor printing machine (1), by controlling the image production equipment (14, 14′, 14″, 14′″) assigned to the image cylinders (12, 12′, 12″, 12′″) for the production of lines of image points (33) on the image cylinders (12, 12′, 12″, 12′″).

12. The apparatus as claimed in claim 11, wherein the control device (8, 8′, 8″, 8′″) is set up in such a way that it assigns the lines of image points (33) to fixed angular sequences (16) of the image cylinders (12, 12′, 12″, 12′″).

13. The apparatus as claimed in claim 12, wherein the control device (8, 8′, 8″, 8′″) is set up in such a way that, in order to achieve coincidence of register between the color separations (7, 7′, . . . ) produced by the color printing units (17, 17′, 17″, 17′″), it subdivides said color separations into areas (10′, 10″, . . . , 10ⁿ) and assigns these areas (10′, 10″, . . . , 10ⁿ) to one another, the areas (10, 10″, . . . , 10ⁿ) consisting of a fixed number of lines of image points (33).

14. The apparatus as claimed in claim 12, wherein it has sensors (21) for measuring the position of elements (12, 12′, 12″, 12′″, 13, 13′, 13″, 18) that carry images and substrates, and the control device (8, 8′, 8″, 8′″) is set up in such a way that it performs the assignment (6, 6′) on the basis of the position measurement.

15. The apparatus as claimed in claim 14, wherein the control device (8, 8′, 8″, 8′″) is set up in such a way that it initiates the printing of register marks (19, 19′, 19″, 19′″), wherein a sensor (22) is arranged to detect the register marks (19, 19′, 19″, 19′″), and wherein the control device (8, 8′, 8″, 8′″) is set up in such a way that it evaluates the data (23) from the register marks (19, 19′, 19″, 19′″) in such a way that the assignment of the areas (10′, 10″, . . . , 10ⁿ) of the color separations (7, 7′, . . . ) to one another is carried out to achieve coincidence of register, and the assignment (6, 6′) of the lines of image points (33) to angular sequences (16) is carried out to reduce the error.

16. A printing machine (1) having a control device (8, 8′, 8″, 8′″) for implementing a method as claimed in claim 1, wherein the control device (8, 8′, 8″, 8′″) is designed in such a way that, for a successive assignment (6, 6′) of two non-coincident digital variables (2 and 2′), it performs an integer assignment (6, 6′) of the small steps (3) of the first variable (2) to a large step (3′) of the second variable (2′) in such a way that the numerical ratio remains constant or is changed in such a way that the assignment error (4, 4′) never reaches the width (5) of the smaller steps (3) of the first variable (2) in any assignment (6, 6′).
